(19) United States
(12) Patent Application Publication
(10) Pub. No.: US 2025/0004622 A1
(43) Pub. Date: Jan. 2, 2025

(54) Object Manipulation in Graphical Environment

(71) Applicant: Apple Inc., Cupertino, CA (US)

(72) Inventors: Connor A. Smith, Sunnyvale, CA (US); Fatima Broom, San Francisco, CA (US); Luis R. Deliz Centeno, Fremont, CA (US); Miao Ren, Sunnyvale, CA (US)

(21) Appl. No.: 18/694,354

(22) PCT Filed: Sep. 2, 2022
(86) PCT No.: PCT/US22/42424

§ 371 Date: Mar. 21, 2024

Related U.S. Application Data
(60) Provisional application No. 63/247,979, filed on Sep. 24, 2021.

(51) Int. Cl. G06F 3/04845; G02B 27/01; G06F 3/01

(52) U.S. Cl. CPC G06F 3/04845; G02B 27/017; G06F 3/013; G06F 3/017

(57) ABSTRACT

Various implementations disclosed herein include devices, systems, and methods for manipulating and/or annotating objects in a graphical environment. In some implementations, a device includes a display, one or more processors, and a memory. In some implementations, a method includes detecting a gesture being performed using a first object in association with a second object in a graphical environment. A distance is determined, via the one or more sensors, between a representation of the first object and the second object. If the distance is greater than a threshold, a change in the graphical environment is displayed according to the gesture and a gaze. If the distance is not greater than the threshold, the change in the graphical environment is displayed according to the gesture and a projection of the representation of the first object on the second object.

### CROSS-REFERENCE TO RELATED APPLICATION

This application claims the benefit of U.S. Provisional Patent App. No. 63/247,979, filed on Sep. 24, 2021, which is incorporated by reference in its entirety.

### TECHNICAL FIELD

The present disclosure generally relates to manipulating objects in a graphical environment.

### BACKGROUND

Some devices are capable of generating and presenting graphical environments that include many objects. These objects may mimic real world objects. These environments may be presented on mobile communication devices.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1B are diagrams of an example operating environment in accordance with some implementations.

FIG. 2 is a block diagram of an example annotation engine in accordance with some implementations.

FIGS. 3A-3B are a flowchart representation of a method of manipulating objects in a graphical environment in accordance with some implementations.

FIG. 4 is a block diagram of a device that manipulates objects in a graphical environment in accordance with some implementations.

FIGS. 5A-5C are diagrams of an example operating environment in accordance with some implementations.

FIG. 6 is a block diagram of an example annotation engine in accordance with some implementations.

FIG. 7 is a flowchart representation of a method of selecting a markup mode in accordance with some implementations.

FIG. 8 is a block diagram of a device that selects a markup mode in accordance with some implementations.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals to denote like features throughout the specification and figures.

### SUMMARY

Various implementations disclosed herein include devices, systems, and methods for manipulating and/or annotating objects in a graphical environment. In some implementations, a device includes a display, one or more processors, and non-transitory memory. In some implementations, a method includes detecting a gesture being performed using a first object in association with a second object in a graphical environment. A distance is determined, via the one or more sensors, between a representation of the first object and the second object. If the distance is greater than a threshold, a change in the graphical environment is displayed according to the gesture and a determined gaze. If the distance is not greater than the threshold, the change in the graphical environment is displayed according to the gesture and a projection of the representation of the first object on the second object.

In some implementations, a method includes detecting a gesture, made by a physical object, directed to a graphical environment comprising a first virtual object and a second virtual object. If the gesture is directed to a location in the graphical environment corresponding to a first portion of the first virtual object, an annotation associated with the first virtual object is generated based on the gesture. If the gesture starts at a location in the graphical environment corresponding to a second portion of the first virtual object and ends at a location in the graphical environment corresponding to the second virtual object, a relationship is defined between the first virtual object and the second virtual object based on the gesture. If the gesture is not directed to a location in the graphical environment corresponding to the first virtual object or the second virtual object, an annotation associated with the graphical environment is generated.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

At least some implementations described herein utilize gaze information to identify objects that the user is focusing on. The collection, storage, transfer, disclosure, analysis, or other use of gaze information should comply with well-established privacy policies and/or privacy practices. Privacy policies and practices that are generally recognized as meeting or exceeding industry or governmental requirements should be implemented and used. The present disclosure also contemplates that the use of a user's gaze information may be limited to what is necessary to implement the described implementations. For instance, in implementations where a user's device provides processing power, the gaze information may be processed locally at the user's device.

Some devices display a graphical environment, such as an extended reality (XR) environment, that includes one or more objects, e.g., virtual objects. A user may wish to manipulate or annotate an object or annotate a workspace in a graphical environment. Gestures can be used to manipulate or annotate objects in a graphical environment. However, gesture-based manipulation and annotation can be imprecise. For example, it can be difficult to determine with precision a location to which a gesture is directed. In addition, inaccuracies in extremity tracking can lead to significant errors in rendering annotations.

The present disclosure provides methods, systems, and/or devices for annotating and/or manipulating objects in a graphical environment, such as a bounded region (e.g., a workspace) or an object in a bounded region. In various implementations, annotations or manipulations can be performed in an indirect mode in which the user's gaze guides manipulation or annotation of the object. The indirect mode may be employed when the distance between a user input entity (e.g., an extremity or a stylus) and the object is greater than a threshold distance. When the distance between the user input entity and the object is less than or equal to the threshold distance, annotations or manipulations may be performed in a direct mode in which manipulation or annotation of the object is guided by a projection of the position of the user input entity on a surface of the object.

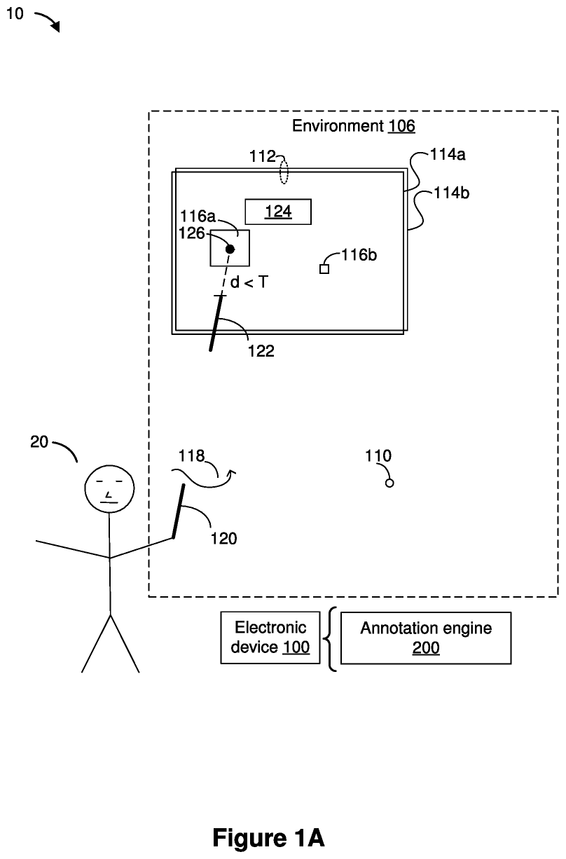

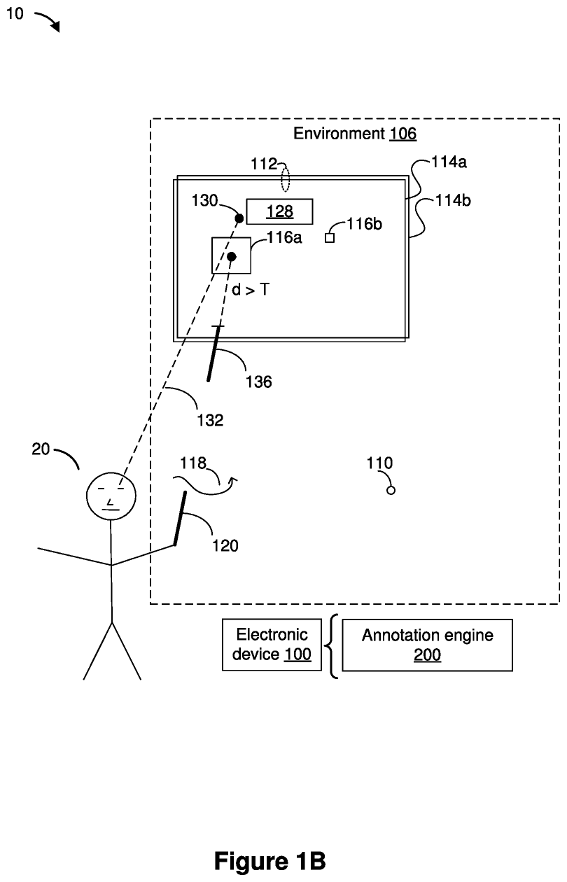

FIG. 1A is a block diagram of an example operating environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 10 includes an electronic device 100 and an annotation engine 200. In some implementations, the electronic device 100 includes a handheld computing device that can be held by a user 20. For example, in some implementations, the electronic device 100 includes a smartphone, a tablet, a media player, a laptop, or the like. In some implementations, the electronic device 100 includes a wearable computing device that can be worn by the user 20. For example, in some implementations, the electronic device 100 includes a head-mountable device (HMD) or an electronic watch.

In the example of FIG. 1A, the annotation engine 200 resides at the electronic device 100. For example, the electronic device 100 implements the annotation engine 200. In some implementations, the electronic device 100 includes a set of computer-readable instructions corresponding to the annotation engine 200. Although the annotation engine 200 is shown as being integrated into the electronic device 100, in some implementations, the annotation engine 200 is separate from the electronic device 100. For example, in some implementations, the annotation engine 200 resides at another device (e.g., at a controller, a server or a cloud computing platform).

As illustrated in FIG. 1A, in some implementations, the electronic device 100 presents an extended reality (XR) environment 106 that includes a field of view of the user 20. In some implementations, the XR environment 106 is referred to as a computer graphics environment. In some implementations, the XR environment 106 is referred to as a graphical environment. In some implementations, the electronic device 100 generates the XR environment 106. In some implementations, the electronic device 100 receives the XR environment 106 from another device that generated the XR environment 106.

In some implementations, the XR environment 106 includes a virtual environment that is a simulated replacement of a physical environment. In some implementations, the XR environment 106 is synthesized by the electronic device 100. In such implementations, the XR environment 106 is different from a physical environment in which the electronic device 100 is located. In some implementations, the XR environment 106 includes an augmented environment that is a modified version of a physical environment. For example, in some implementations, the electronic device 100 modifies (e.g., augments) the physical environment in which the electronic device 100 is located to generate the XR environment 106. In some implementations, the electronic device 100 generates the XR environment 106 by simulating a replica of the physical environment in which the electronic device 100 is located. In some implementations, the electronic device 100 generates the XR environment 106 by removing items from and/or adding items to the simulated replica of the physical environment in which the electronic device 100 is located.

In some implementations, the XR environment 106 includes various virtual objects such as an XR object 110 (“object 110”, hereinafter for the sake of brevity). In some implementations, the XR environment 106 includes multiple objects. In some implementations, the virtual objects are referred to as graphical objects or XR objects. In various implementations, the electronic device 100 obtains the objects from an object datastore (not shown). For example, in some implementations, the electronic device 100 retrieves the object 110 from the object datastore. In some implementations, the virtual objects represent physical articles. For example, in some implementations, the virtual objects represent equipment (e.g., machinery such as planes, tanks, robots, motorcycles, etc.). In some implementations, the virtual objects represent fictional elements (e.g., entities from fictional materials, for example, an action figure or a fictional equipment such as a flying motorcycle).

In some implementations, the virtual objects include a bounded region 112, such as a virtual workspace. The bounded region 112 may include a two-dimensional virtual surface 114a enclosed by a boundary and a two-dimensional virtual surface 114b that is substantially parallel to the two-dimensional virtual surface 114a. Objects 116a, 116b may be displayed on either of the two-dimensional virtual surfaces 114a, 114b. In some implementations, the objects 116a, 116b are displayed between the two-dimensional virtual surfaces 114a, 114b. In other implementations, bounded region 112 may be replaced by a single flat or curved two-dimensional virtual surface.

In various implementations, the electronic device 100 (e.g., the annotation engine 200) detects a gesture 118 being performed in association with an object in the XR environment 106. For example, the user 20 may perform the gesture 118 using a user input entity 120, such as an extremity (e.g., a hand or a finger), a stylus or other input device, or a proxy for an extremity or an input device. As represented in FIG. 1A, the user 20 may direct the gesture 118, for example, to the object 116a. In other examples, the object may include the bounded region 112, one or both of the two-dimensional virtual surfaces 114a, 114b of the bounded region 112, or another virtual surface.

In some implementations, the electronic device 100 (e.g., the annotation engine 200) determines a distance d between a representation 122 of the user input entity 120 and the object to which the gesture 118 is directed, e.g., the object 116a. The electronic device 100 may use one or more sensors to determine the distance d. For example, the electronic device 100 may use an image sensor and/or a depth sensor to determine the distance d between the representation 122 of the user input entity 120 and the object 116a. In some implementations, the representation 122 of the user input entity 120 is the user input entity 120 itself. For example, the electronic device 100 may be implemented as a head-mountable device (HMD) with a passthrough display. An image sensor and/or a depth sensor may be used to determine the distance between an extremity of the user 20 and the object to which the gesture 118 is directed. In this example, the XR environment may include both physical objects (e.g., the user input entity 120) and virtual objects (e.g., object 116a) defined within a common coordinate system of the XR environment 106. Thus, while one object may exist in the physical world and the other may not, a distance or orientation difference may still be defined between the two. In some implementations, the representation 122 of the user input entity 120 is an image of the user input entity 120. For example, the electronic device 100 may incorporate a display that displays an image of an extremity of the user 20. The electronic device 100 may determine the distance d between the image of the extremity of the user 20 and the object to which the gesture 118 is directed.

As represented in FIG. 1A, the distance d may be within (e.g., no greater than) a threshold T. In some implementations, when the distance d is within the threshold T, the electronic device 100 (e.g., the annotation engine 200) displays a change in the XR environment 106 according to the gesture 118 and a position associated with the user input entity 120, e.g., a projection of the user input entity on a surface. For example, the electronic device 100 may create an annotation 124. The annotation 124 may be displayed at a location in the XR environment 106 that is determined based on a projection 126 of the user input entity 120 on the object to which the gesture 118 is directed. In some implementations, the electronic device 100 uses one or more image sensors (e.g., a scene-facing image sensor) to obtain an image representing the user input entity 120 in the XR environment 106. The electronic device 100 may determine that a subset of pixels in the image represents the user input entity 120 in a pose corresponding to a defined gesture, e.g., a pinching or pointing gesture. In some implementations, when the electronic device 100 determines that the user is performing the defined gesture, the electronic device 100 begins creating the annotation 124. For example, the electronic device 100 may generate a mark. In some implementations, the electronic device 100 renders the annotation 124 (e.g., the mark) to follow the motion of the user input entity 120 as long as the gesture 118 (e.g., the pinching gesture) is maintained. In some implementations, the electronic device 100 ceases rendering the annotation 124 when the gesture 118 is no longer maintained. In some implementations, the annotation 124 may be displayed at a location corresponding to the location of the user input entity 120 without the use of a gaze vector. For example, the annotation 124 may be positioned at a location on virtual surface 114a closest to a portion of the user input entity 120 (e.g., an end, middle), an average location of the user input entity 120, a gesture location of the user input entity 120 (e.g., a pinch location between two fingers), a predefined offset from the user input entity 120, or the like.

As represented in FIG. 1B, the distance d may be greater than the threshold T. In some implementations, when the distance d is greater than the threshold T, the electronic device 100 (e.g., the annotation engine 200) displays the change in the XR environment 106 according to the gesture 118 and a gaze of the user 20. For example, the electronic device 100 may use one or more sensors (e.g., a scene-facing image sensor) to obtain an image representing the user input entity 120 in the XR environment 106. The electronic device 100 may determine that a subset of pixels in the image represents the user input entity 120 in a pose corresponding to a defined gesture, e.g., a pinching or pointing gesture. In some implementations, when the electronic device 100 determines that the user is performing the defined gesture, the electronic device 100 begins creating an annotation 128. The annotation 128 may be rendered at a location 130 corresponding to a gaze vector 132, e.g., an intersection of the gaze vector 132 and the bounded region 112. In some implementations, an image sensor (e.g., a user-facing image sensor) obtains an image of the user's pupils. The image may be used to determine the gaze vector 132. In some implementations, the electronic device 100 continues to render the annotation 128 according to a motion (e.g., relative motion) of the user input entity 120. For example, the electronic device 100 may render the annotation 128 beginning at the location 130 and following the motion of the user input entity 120 as long as the defined gesture is maintained. In some implementations, the electronic device 100 ceases rendering the annotation 128 when the defined gesture is no longer maintained. In some implementations, if the distance d is greater than the threshold T, a representation 136 of the user input entity 120 is displayed in the XR environment 106.

In some implementations, if the distance d is greater than the threshold T, the electronic device 100 determines the location 130 at which the annotation 128 is rendered based on the gaze vector 132 and an offset. The offset may be determined based on a position of the user input entity 120. For example, if the user input entity 120 is the user's hand, the user 20 may exhibit a tendency to look at the hand while performing the gesture 118. This tendency may be particularly pronounced if the user 20 is unfamiliar with the operation of the electronic device 100. If the location 130 at which the annotation 128 is rendered is determined based only on the gaze vector 132 (e.g., without applying an offset), the annotation 128 may be rendered at a location behind and occluded by the user's hand. To compensate for the tendency of the user 20 to look at the user input entity 120 (e.g., their hand) while performing the gesture 118, the electronic device 100 may apply an offset so that the location 130 is located at a nonoccluded location. For example, the offset may be selected such that the location 130 is located at an end portion of the user's hand, e.g., a fingertip. Applying an offset to the gaze vector 128 may cause an annotation to be displayed at a location intended by the user.

In some implementations, the change in the XR environment 106 that is displayed is the creation of an annotation, e.g., the annotation 124 of FIG. 1A or the annotation 128 of FIG. 1B. An annotation may include an object, such as a text object or a graphic object, that may be associated with another object in the XR environment, such as the object 116a. In some implementations, the change in the XR environment 106 that is displayed is the modification of an annotation. For example, annotations can be edited, moved, or associated with other objects. In some implementations, the change in the XR environment 106 that is displayed is the removal of an annotation that is associated with an object.

In some implementations, the change in the XR environment 106 that is displayed is the manipulation of an object. For example, if the gesture 118 is directed to the object 116a, the electronic device 100 may display a movement of the object 116a or an interaction with the object 116a. In some implementations, a direction of the displayed movement of the object 116a is determined according to the gesture 118 and the gaze of the user 20 if the distance d between the representation 122 of the user input entity 120 and the object 116a is greater than the threshold T. In some implementations, the direction of the displayed movement of the object 116a is determined according to the gesture 118 and the projection 130 of the user input entity 120 on the object 116a if the distance d is within the threshold T.

In some implementations, a magnitude of the change that is displayed in the XR environment 106 is modified based on a distance between the user input entity 120 and the object or target location. For example, a scale factor may be applied to the gesture 118. The scale factor may be determined based on the distance between the user input entity 120 and the object or location to which the gesture 118 is directed. For example, if the distance between the user input entity 120 and the object is small, the scale factor may also be small. A small scale factor allows the user 20 to exercise fine control over the displayed change in the XR environment 106. If the distance between the user input entity 120 and the object is larger, the electronic device 100 may apply a larger scale factor to the gesture 118, such that the user 20 can cover a larger area of the field of view with the gesture 118.

In some implementations, the electronic device 100 selects a brush stroke type based on the distance between the user input entity 120 and the object or location to which the gesture 118 is directed. For example, if the distance between the user input entity 120 and the object or location is less than a first threshold, a first brush style (e.g., a fine point) may be selected. If the distance between the user input entity 120 and the object or location is between the first threshold and a greater, second threshold, a second brush style (e.g., a medium point) may be selected. If the distance between the user input entity 120 and the object or location is greater than the second threshold, a third brush style (e.g., a broad point) may be selected. The distance between the user input entity 120 and the object or location may also be used to select a brush type. For example, if the distance between the user input entity 120 and the object or location is less than the first threshold, a first brush type (e.g., a pen) may be selected. If the distance between the user input entity 120 and the object or location is between the first threshold and a greater, second threshold, a second brush type (e.g., a highlighter) may be selected. If the distance between the user input entity 120 and the object or location is greater than the second threshold, a third brush type (e.g., an eraser) may be selected.

In some implementations, the electronic device 100 includes or is attached to a head-mountable device (HMD) that can be worn by the user 20. The HMD presents (e.g., displays) the XR environment 106 according to various implementations. In some implementations, the HMD includes an integrated display (e.g., a built-in display) that displays the XR environment 106. In some implementations, the HMD includes a head-mountable enclosure. In various implementations, the head-mountable enclosure includes an attachment region to which another device with a display can be attached. For example, in some implementations, the electronic device 100 can be attached to the head-mountable enclosure. In various implementations, the head-mountable enclosure is shaped to form a receptacle for receiving another device that includes a display (e.g., the electronic device 100). For example, in some implementations, the electronic device 100 slides/snaps into or otherwise attaches to the head-mountable enclosure. In some implementations, the display of the device attached to the head-mountable enclosure presents (e.g., displays) the XR environment 106. In various implementations, examples of the electronic device 100 include smartphones, tablets, media players, laptops, etc.

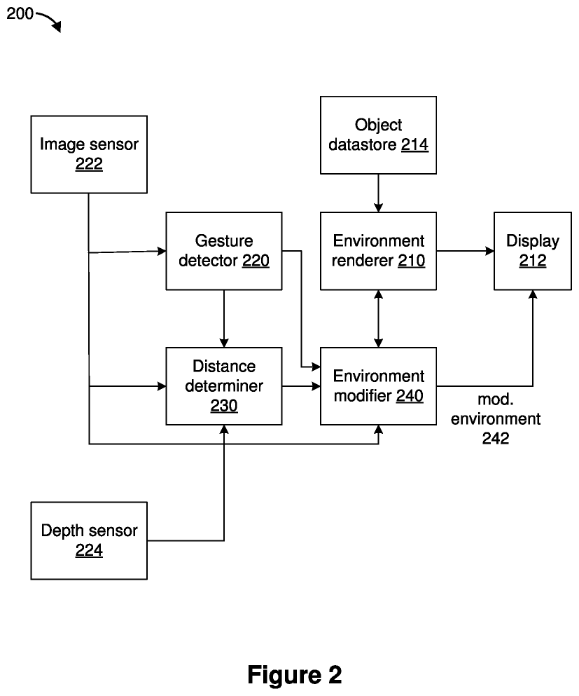

FIG. 2 illustrates a block diagram of the annotation engine 200 in accordance with some implementations. In some implementations, the annotation engine 200 includes an environment renderer 210, a gesture detector 220, a distance determiner 230, and an environment modifier 240. In various implementations, the environment renderer 210 causes a display 212 to present an extended reality (XR) environment that includes one or more virtual objects in a field of view. For example, with reference to FIGS. 1A and 1B, the environment renderer 210 may cause the display 212 to present the XR environment 106, including the XR object 110. In various implementations, the environment renderer 210 obtains the virtual objects from an object datastore 214. The virtual objects may represent physical articles. For example, in some implementations, the virtual objects represent equipment (e.g., machinery such as planes, tanks, robots, motorcycles, etc.). In some implementations, the virtual objects represent fictional elements.

In some implementations, the gesture detector 220 detects a gesture that a user performs with a user input entity (e.g., an extremity or a stylus) in association with an object or location in the XR environment. For example, an image sensor 222 may capture an image, such as a still image or a video feed comprising a series of image frames. The image may include a set of pixels representing the user input entity. The gesture detector 220 may perform image analysis on the image to recognize the user input entity and detect the gesture (e.g., a pinching gesture, pointing gesture, holding a writing instrument gesture, or the like) performed by the user.

In some implementations, the distance determiner 230 determines a distance between a representation of the user input entity and the object or location associated with the gesture. The distance determiner 230 may use one or more sensors to determine the distance. For example, the image sensor 222 may capture an image that includes a first set of pixels that represents the user input entity and a second set of pixels that represents the object or location associated with the gesture. The distance determiner 230 may perform image analysis on the image to recognize the representation of the user input entity and the object or location and to determine the distance between the representation of the user input entity and the object or location. In some implementations, the distance determiner 230 uses a depth sensor to determine the distance between the representation of the user input entity and the object.

In other implementations, other types of sensing modalities may be used. For example, a finger-wearable device, hand-wearable device, handheld device, or the like may have integrated sensors (e.g., accelerometers, gyroscopes, etc.) that can be used to sense its position or orientation and communicate (wired or wirelessly) the position or orientation information to electronic device 100. These devices may additionally or alternatively include sensor components that work in conjunction with sensor components in electronic device 100. The user input entity and electronic device 100 may implement magnetic tracking to sense a position and orientation of the user input entity in six degrees of freedom.

In some implementations, if the distance is greater than the threshold, the distance determiner 230 determines the location at which an annotation is rendered based on a gaze vector and an offset. Applying an offset to the gaze vector may compensate for a tendency of the user to look at the user input entity (e.g., their hand) while performing the gesture, causing the endpoint of the unadjusted gaze vector to be located behind the user input entity. The offset may be determined based on a position of the user input entity. For example, if the user input entity is the user's hand, the offset may be applied to the gaze vector (e.g., an endpoint of the gaze vector) so that the annotation is rendered at an end portion of the user's hand, e.g., a fingertip or between two fingers pinching. Applying an offset to the gaze vector may cause an annotation to be displayed at a location intended by the user. In some implementations, the offset is applied during the initial rendering of the annotation, e.g., when the location of the rendering is determined based in part on the gaze vector. After the initial rendering, the location at which the annotation is rendered may be determined by (e.g., may follow) the motion of the user input entity, and the offset may no longer be applied.

The representation of the user input entity may be the user input entity itself. For example, the user input entity may be viewed through a passthrough display. The distance determiner 230 may use the image sensor 222 and/or a depth sensor 224 to determine the distance between the user input entity and the object or location to which the gesture is directed. In some implementations, the representation of the user input entity is an image of the user input entity. For example, the electronic device may incorporate a display that displays an image of the user input entity. The distance determiner 230 may determine the distance between the image of the user input entity and the object or location to which the gesture is directed.

In some implementations, the environment modifier 240 modifies the XR environment to represent a change in the XR environment and generates a modified XR environment 242, which is displayed on the display 212. The change may be the creation of an annotation. An annotation may include an object, such as a text object or a graphic object, that may be associated with another object or location in the XR environment. In some implementations, the change in the XR environment is the modification of an annotation. For example, annotations can be edited, moved, or associated with other objects or location. In some implementations, the change in the XR environment is the removal of an annotation that is associated with an object or location.

In some implementations, the environment modifier 240 determines how to modify the XR environment based on the distance between the representation of the user input entity and the object or location to which the gesture is directed. For example, if the distance is greater than a threshold, the environment modifier 240 may modify the XR environment according to the gesture and a gaze of the user. In some implementations, the environment modifier 240 uses one or more image sensors (e.g., the image sensor 222) to determine a location in the XR environment to which the user's gaze is directed. For example, the image sensor 222 may obtain an image of the user's pupils. The image may be used to determine a gaze vector. The environment modifier 240 may use the gaze vector to determine the location at which the change in the XR environment is to be displayed.

As another example, the distance between the representation of the user input entity and the object or location to which the gesture is directed may be greater than the threshold. In some implementations, when the distance is within (e.g., no greater than) the threshold, the environment modifier 240 displays the change in the XR environment according to the gesture and a projection of the user input entity on the object or location to which the gesture is directed. In some implementations, the environment modifier 240 determines a location that corresponds to the projection of the user input entity on the object or location to which the gesture is directed. The environment modifier 240 may modify the XR environment to include an annotation that is to be displayed at the location. In some implementations, if the distance is greater than the threshold, the environment modifier 240 modifies the XR environment to include a representation of the user input entity.

In some implementations, the environment modifier 240 modifies the XR environment to represent a manipulation of an object. For example, the environment modifier 240 may modify the XR environment to represent a movement of the object or an interaction with the object. In some implementations, a direction of the displayed movement of the object is determined according to the gesture and the gaze of the user if the distance between the representation of the user input entity and the object is greater than the threshold. In some implementations, the direction of the displayed movement of the object is determined according to the gesture and the projection of the user input entity on the object if the distance is within (e.g., not greater than) the threshold.

In some implementations, the environment modifier 240 modifies a magnitude of the change that is displayed in the XR environment based on a distance between the user input entity and the object or location. For example, the environment modifier 240 may apply a scale factor to the gesture. The scale factor may be determined based on the distance between the user input entity and the object or location to which the gesture is directed. For example, if the distance between the user input entity and the object or location is small, the scale factor may also be small. A small scale factor allows the user to exercise fine control over the displayed change in the XR environment. If the distance between the user input entity and the object or location is larger, the environment modifier 240 may apply a larger scale factor to the gesture, such that the user can cover a larger area of the field of view with the gesture. In some implementations, the scale factor applied to the gesture may be determined at the start of the gesture and applied through the end of the gesture. For example, in response to a pinch gesture applied two meters away from a virtual writing surface, a scale factor of two may be applied to the user's subsequent vertical and horizontal hand motions while the pinch is maintained, regardless of any changes in distance between the user's hand and the virtual writing surface. This may advantageously provide the user with a more consistent writing or drawing experience despite unintentional motion in the Z-direction. In other implementations, the scale factor applied to the gesture may be dynamic in response to changes in distance between the user input entity and the virtual writing surface throughout the gesture.

In some implementations, the environment modifier 240 selects a brush stroke type based on the distance between the user input entity and the object to which the gesture is directed. For example, if the distance between the user input entity and the object is less than a first threshold, a first brush style (e.g., a fine point) may be selected. If the distance between the user input entity and the object is between the first threshold and a greater, second threshold, a second brush style (e.g., a medium point) may be selected. If the distance between the user input entity and the object is greater than the second threshold, a third brush style (e.g., a broad point) may be selected. The distance between the user input entity and the object may also be used to select a brush type. For example, if the distance between the user input entity and the object is less than the first threshold, a first brush type (e.g., a pen) may be selected. If the distance between the user input entity and the object is between the first threshold and a greater, second threshold, a second brush type (e.g., a highlighter) may be selected. If the distance between the user input entity and the object is greater than the second threshold, a third brush type (e.g., an eraser) may be selected.

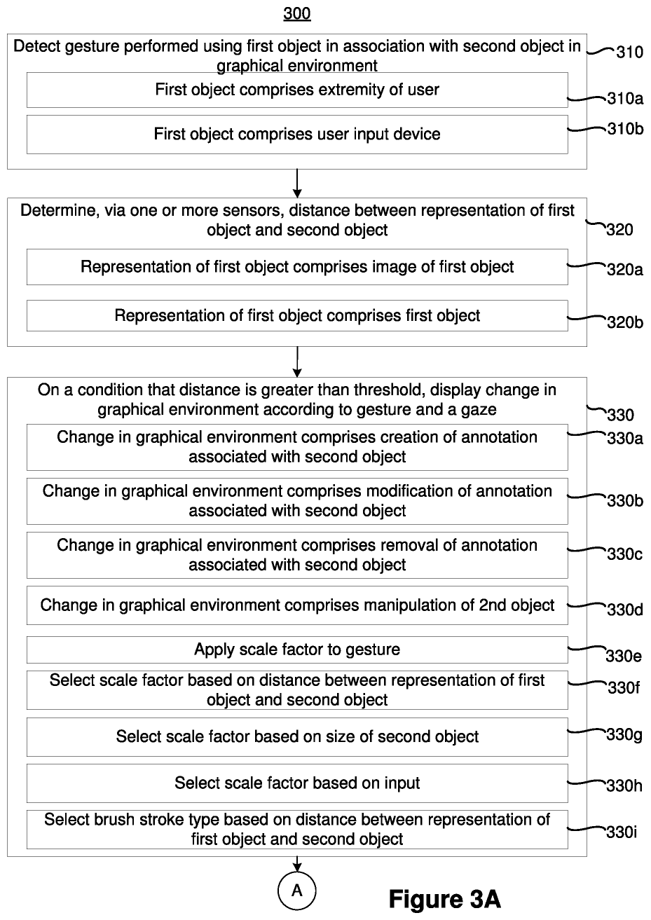

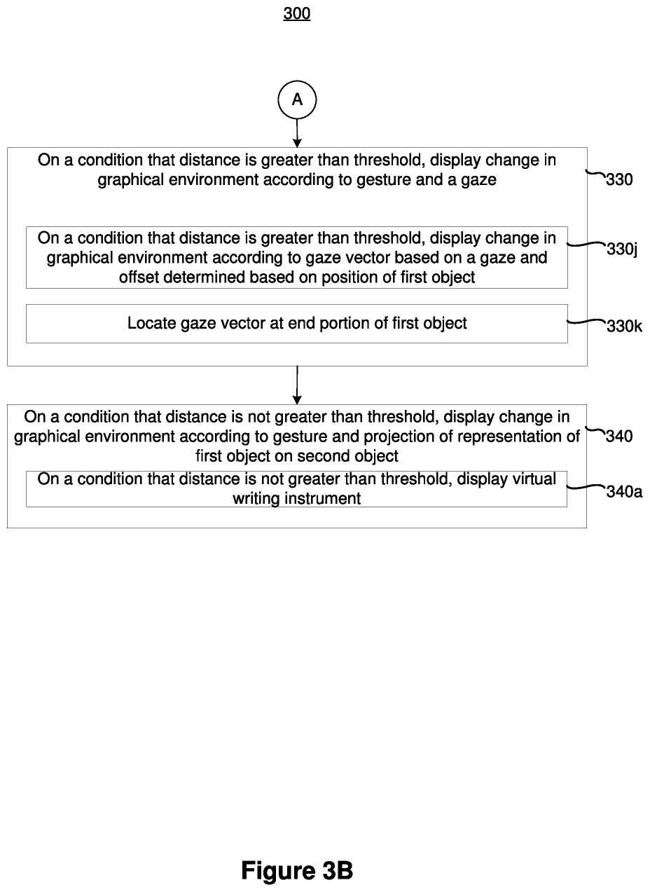

FIGS. 3A-3B are a flowchart representation of a method 300 for manipulating objects in a graphical environment in accordance with various implementations. In various implementations, the method 300 is performed by a device (e.g., the electronic device 100 shown in FIGS. 1A-1B, or the annotation engine 200 shown in FIGS. 1A-1B and 2). In some implementations, the method 300 is performed by processing logic, including hardware, firmware, software, or a combination thereof. In some implementations, the method 300 is performed by a processor executing code stored in a non-transitory computer-readable medium (e.g., a memory).

In various implementations, an XR environment comprising a field of view is displayed. In some implementations, the XR environment is generated. In some implementations, the XR environment is received from another device that generated the XR environment.

The XR environment may include a virtual environment that is a simulated replacement of a physical environment. In some implementations, the XR environment is synthesized and is different from a physical environment in which the electronic device is located. In some implementations, the XR environment includes an augmented environment that is a modified version of a physical environment. For example, in some implementations, the electronic device modifies the physical environment in which the electronic device is located to generate the XR environment. In some implementations, the electronic device generates the XR environment by simulating a replica of the physical environment in which the electronic device is located. In some implementations, the electronic device removes and/or adds items from the simulated replica of the physical environment in which the electronic device is located to generate the XR environment.

In some implementations, the electronic device includes a head-mountable device (HMD). The HMD may include an integrated display (e.g., a built-in display) that displays the XR environment. In some implementations, the HMD includes a head-mountable enclosure. In various implementations, the head-mountable enclosure includes an attachment region to which another device with a display can be attached. In various implementations, the head-mountable enclosure is shaped to form a receptacle for receiving another device that includes a display. In some implementations, the display of the device attached to the head-mountable enclosure presents (e.g., displays) the XR environment. In various implementations, examples of the electronic device include smartphones, tablets, media players, laptops, etc.

Briefly, the method 300 includes detecting a gesture that is performed using a first object in association with a second object in a graphical environment. One or more sensors are used to determine a distance between a representation of the first object and the second object. If the distance is greater than a threshold, a change is displayed in the graphical environment according to the gesture and a determined gaze. If the distance is not greater than the threshold, the change is displayed in the graphical environment according to the gesture and a projection of the representation of the first object on the second object.

In various implementations, as represented by block 310, the method 300 includes detecting a gesture being performed using a first object in association with a second object in a graphical environment. A user may perform the gesture using a first object. In some implementations, as represented by block 310a, the first object comprises an extremity of the user, such as a hand. As represented by block 310b, in some implementations, the first object comprises a user input device, such as a stylus. In some implementations, the gesture may include a pinching gesture between fingers of the user's hand.

In various implementations, as represented by block 320, the method 300 includes determining, via one or sensors, a distance between a representation of the first object and the second object. For example, an image sensor and/or a depth sensor may be used to determine the distance between the representation of the first object and the second object. In some implementations, as represented by block 320a, the representation of the first object comprises an image of the first object. For example, the electronic device may incorporate a display that displays an image of an extremity of the user. The electronic device may determine the distance between the image of the extremity of the user and the second object associated with the gesture. As represented by block 320b, in some implementations, the representation of the first object comprises the first object. For example, the electronic device may be implemented as a head-mountable device (HMD) with a passthrough display. An image sensor and/or a depth sensor may be used to determine the distance between an extremity of the user and the second object associated with the gesture.

In various implementations, as represented by block 330, the method 300 includes displaying a change in the graphical environment according to the gesture and a gaze of the user on a condition that the distance is greater than a threshold. For example, as represented by block 330a, the change in the graphical environment may comprise a creation of an annotation associated with the second object. The annotation may be displayed at a location in the graphical environment that is determined based on the gaze of the user 20. In some implementations, one or more image sensors (e.g., a user-facing image sensor) are used to determine a location in the graphical environment to which the user's gaze is directed. For example, a user-facing image sensor may obtain an image of the user's pupils. The image may be used to determine a gaze vector. The gaze vector may be used to determine the location. In some implementations, the annotation is displayed at the location.

As represented by block 330b, the change in the graphical environment may comprise a modification of an annotation. For example, annotations can be edited, moved, or associated with other objects. In some implementations, as represented by block 330c, the change in the graphical environment comprises a removal of an annotation that is associated with an object.

In some implementations, as represented by block 330d, the change in the graphical environment comprises a manipulation of an object. For example, the electronic device may display a movement of the second object or an interaction with the second object. In some implementations, a direction of the displayed movement of the second object is determined according to the gesture and the gaze of the user if the distance between the representation of the first object and the second object is within the threshold. In some implementations, the direction of the displayed movement of the second object is determined according to the gesture and the projection of the first object on the second object if the distance is greater than the threshold.

In some implementations, a magnitude of the change that is displayed in the graphical environment is modified based on a distance between the first object and the second object. For example, as represented by block 330e, a scale factor may be applied to the gesture. As represented by block 330f, the scale factor may be selected based on the distance between the representation of the first object and the second object. For example, if the distance between the first object and the second object is small, the scale factor may also be small to facilitate exercising fine control over the displayed change in the graphical environment. If the distance between the first object and the second object is larger, a larger scale factor may be applied to the gesture to facilitate covering a larger area of the field of view with the gesture. In some implementations, as represented by block 330g, the scale factor is selected based on a size of the second object. For example, if the second object is large, the scale factor may be large to facilitate covering a larger portion of the second object with the gesture. In some implementations, as represented by block 330h, the scale factor is selected based on a user input. For example, the user may provide a user input to override a scale factor that was preselected based on the criteria disclosed herein. As another example, the user may provide a user input to select the scale factor using, e.g., a numeric input field or a slider affordance.

In some implementations, as represented by block 330i, the method 300 includes selecting a brush stroke type based on the distance between the representation of the first object and the second object. For example, if the distance is less than a first threshold, a first brush style (e.g., a fine point) may be selected. If the distance is between the first threshold and a second threshold, a second brush style (e.g., a medium point) may be selected. If the distance is greater than the second threshold, a third brush style (e.g., a broad point) may be selected. The distance may also be used to select a brush type. For example, if the distance is less than the first threshold, a first brush type (e.g., a pen) may be selected. If the distance is between the first threshold and a second threshold, a second brush type (e.g., a highlighter) may be selected. If the distance is greater than the second threshold, a third brush type (e.g., an eraser) may be selected.

In some implementations, as represented by block 330j of FIG. 3B, if the distance is greater than the threshold, the electronic device displays the change in the graphical environment according to a gaze vector based on the gaze of the user and an offset. The offset may be determined based on a position of the first object. For example, as represented by block 330k, if the first object is the user's hand, the change in the graphical environment may be displayed at a location corresponding to an end portion of the user's hand, e.g., a fingertip. In this way, the electronic device may compensate for a tendency of the user to look at the first object (e.g., their hand) while performing the gesture. This tendency may be particularly pronounced if the user is unfamiliar with the operation of the electronic device. Applying an offset to the gaze vector may cause an annotation to be displayed at a location intended by the user.

In various implementations, as represented by block 340, the method 300 includes displaying a change in the graphical environment according to the gesture and a projection of the first object on the second object on a condition that the distance is not greater than the threshold. The electronic device may determine a location that corresponds to the projection of the first object on the second object. The electronic device may create an annotation that is displayed at the location. In some implementations, as represented by block 340a, if the distance is not greater than the threshold, a virtual writing instrument is displayed in the graphical environment.

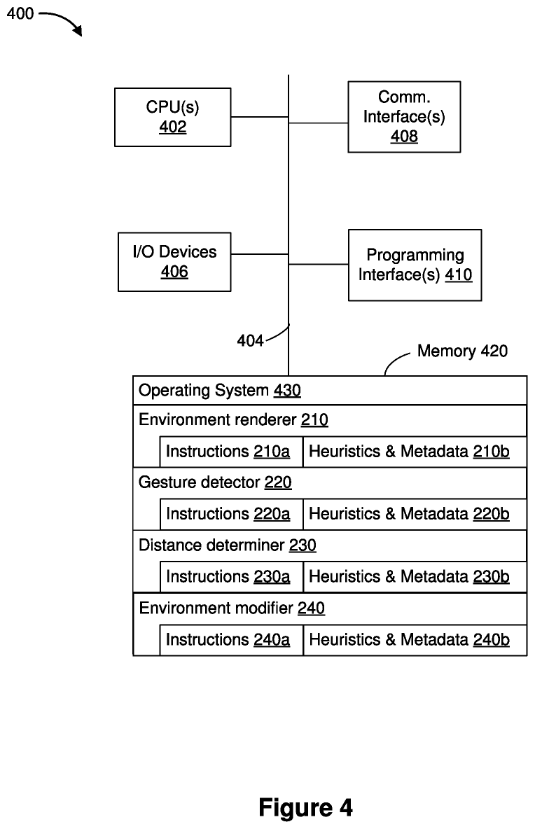

FIG. 4 is a block diagram of a device 400 in accordance with some implementations. In some implementations, the device 400 implements the electronic device 100 shown in FIGS. 1A-1B, and/or the annotation engine 200 shown in FIGS. 1A-1B and 2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (CPUs) 401, a network interface 402, a programming interface 403, a memory 404, one or more input/output (I/O) devices 410, and one or more communication buses 405 for interconnecting these and various other components.

In some implementations, the network interface 402 is provided to, among other uses, establish and/or maintain a metadata tunnel between a cloud hosted network management system and at least one private network including one or more compliant devices. In some implementations, the one or more communication buses 405 include circuitry that interconnects and/or controls communications between system components. In some implementations, the memory 404 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 404 may include one or more storage devices remotely located from the one or more CPUs 401. The memory 404 includes a non-transitory computer readable storage medium.

In some implementations, the memory 404 or the non-transitory computer readable storage medium of the memory 404 stores the following programs, modules and data structures, or a subset thereof including an optional operating system 406, the environment renderer 210, the gesture detector 220, the distance determiner 230, and the environment modifier 240. In various implementations, the device 400 performs the method 300 shown in FIGS. 3A-3B.

In some implementations, the environment renderer 210 displays an extended reality (XR) environment that includes one or more virtual objects in a field of view. In some implementations, the environment renderer 210 performs some operation(s) represented by blocks 330 and 340 in FIGS. 3A-3B. To that end, the environment renderer 210 includes instructions 210a and heuristics and metadata 210b.

In some implementations, the gesture detector 220 detects a gesture that a user performs with a user input entity (e.g., an extremity or a stylus) in association with an object in the XR environment. In some implementations, the gesture detector 220 performs the operation(s) represented by block 310 in FIGS. 3A-3B. To that end, the gesture detector 220 includes instructions 220a and heuristics and metadata 220b.

In some implementations, the distance determiner 230 determines a distance between a representation of the user input entity and the object associated with the gesture. In some implementations, the distance determiner 230 performs the operations represented by block 320 in FIGS. 3A-3B. To that end, the distance determiner 230 includes instructions 230a and heuristics and metadata 230b.

In some implementations, the environment modifier 240 modifies the XR environment to represent a change in the XR environment and generates a modified XR environment. In some implementations, the environment modifier 240 performs the operations represented by blocks 330 and 340 in FIGS. 3A-3B. To that end, the environment modifier 240 includes instructions 240a and heuristics and metadata 240b.

In some implementations, the one or more I/O devices 410 include a user-facing image sensor. In some implementations, the one or more I/O devices 410 include one or more head position sensors that sense the position and/or motion of the head of the user. In some implementations, the one or more I/O devices 410 include a display for displaying the graphical environment (e.g., for displaying the XR environment 106). In some implementations, the one or more I/O devices 410 include a speaker for outputting an audible signal.

In various implementations, the one or more I/O devices 410 include a video pass-through display which displays at least a portion of a physical environment surrounding the device 400 as an image captured by a scene camera. In various implementations, the one or more I/O devices 410 include an optical see-through display which is at least partially transparent and passes light emitted by or reflected off the physical environment.

FIG. 4 is intended as a functional description of various features which may be present in a particular implementation as opposed to a structural schematic of the implementations described herein. Items shown separately could be combined and some items could be separated. For example, some functional blocks shown separately in FIG. 4 could be implemented as a single block, and various functions of single functional blocks may be implemented by one or more functional blocks in various implementations. The actual number of blocks and the division of particular functions and how features are allocated among them can vary from one implementation to another and, in some implementations, may depend in part on the particular combination of hardware, software, and/or firmware chosen for a particular implementation.

The present disclosure provides methods, systems, and/or devices for selecting a markup mode. In various implementations, the markup mode may be selected based on a location of a gesture relative to an object. In some implementations, if a gesture is not directed to an object, a drawing mode may be selected in which the user can draw on a workspace. If the gesture is directed to an object, an annotating mode may be selected in which the user can create annotations that are anchored to objects in the workspace. If the gesture is performed near a designated portion of the object (e.g., an edge region), a connecting mode may be selected in which the user can define relationships between objects. Selecting the markup mode based on the location of the gesture relative to an object may improve the user experience by reducing the potential for confusion associated with requiring the user to switch between multiple markup modes manually. Battery life may be conserved by avoiding unnecessary user inputs to correct for inadvertent switches between markup modes.

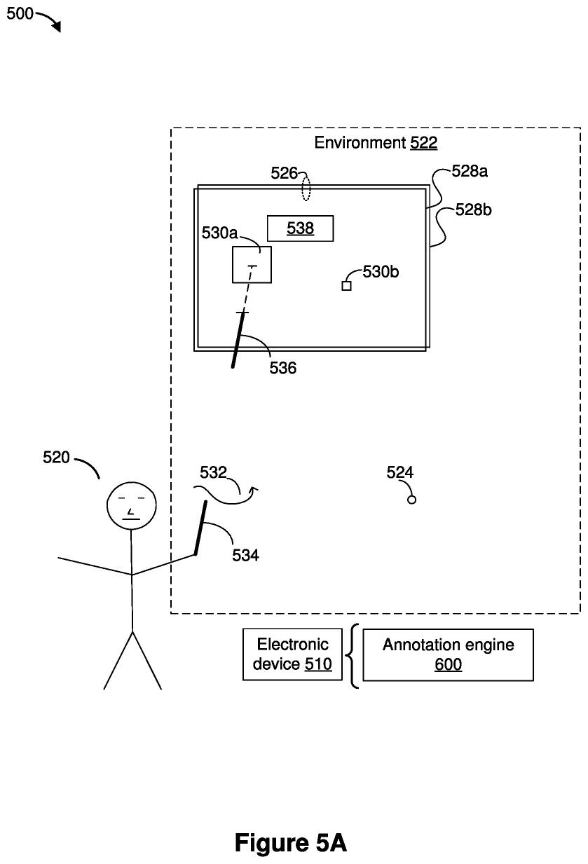

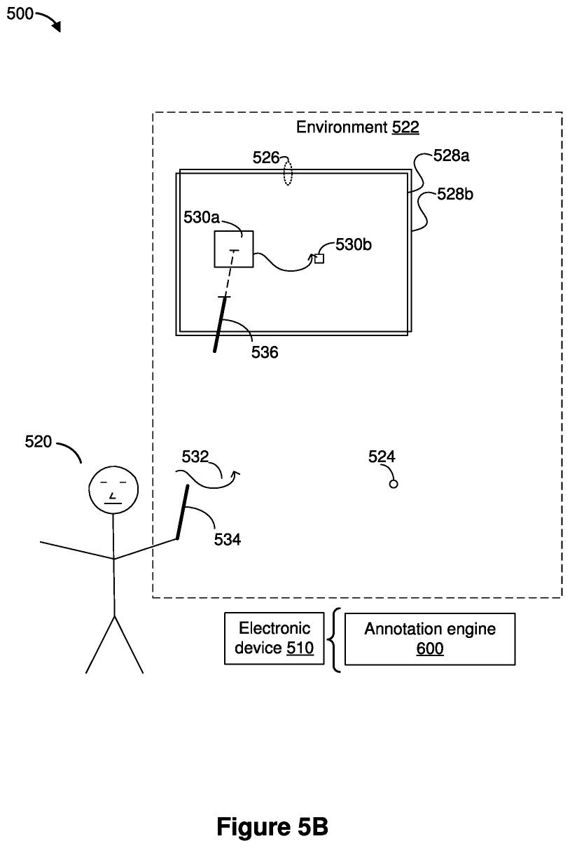

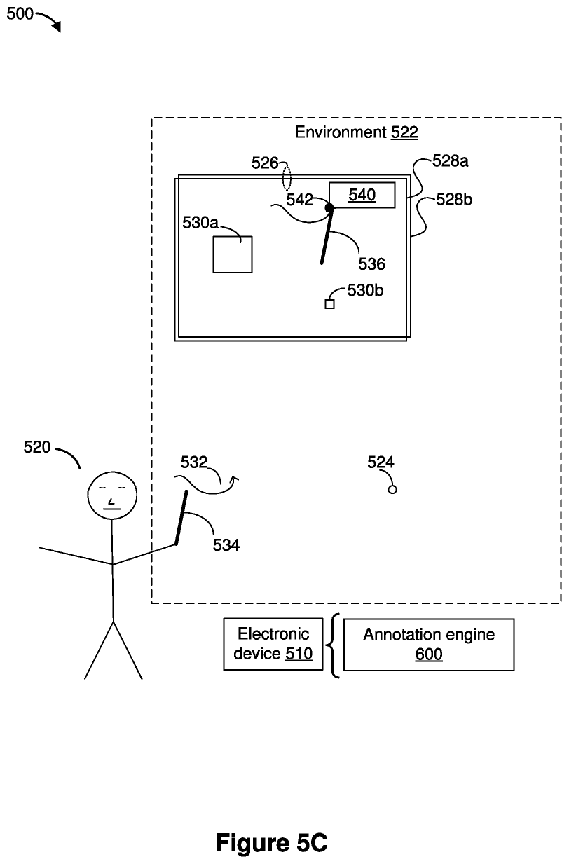

FIG. 5A is a block diagram of an example operating environment 500 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 500 includes an electronic device 510 and an annotation engine 600. In some implementations, the electronic device 510 includes a handheld computing device that can be held by a user 520. For example, in some implementations, the electronic device 510 includes a smartphone, a tablet, a media player, a laptop, or the like. In some implementations, the electronic device 510 includes a wearable computing device that can be worn by the user 520. For example, in some implementations, the electronic device 510 includes a head-mountable device (HMD) or an electronic watch.

In the example of FIG. 5A, the annotation engine 600 resides at the electronic device 510. For example, the electronic device 510 implements the annotation engine 600. In some implementations, the electronic device 510 includes a set of computer-readable instructions corresponding to the annotation engine 600. Although the annotation engine 600 is shown as being integrated into the electronic device 510, in some implementations, the annotation engine 600 is separate from the electronic device 510. For example, in some implementations, the annotation engine 600 resides at another device (e.g., at a controller, a server or a cloud computing platform).

As illustrated in FIG. 5A, in some implementations, the electronic device 510 presents an extended reality (XR) environment 522 that includes a field of view of the user 520. In some implementations, the XR environment 522 is referred to as a computer graphics environment. In some implementations, the XR environment 522 is referred to as a graphical environment. In some implementations, the electronic device 510 generates the XR environment 522. In some implementations, the electronic device 510 receives the XR environment 522 from another device that generated the XR environment 522.

In some implementations, the XR environment 522 includes a virtual environment that is a simulated replacement of a physical environment. In some implementations, the XR environment 522 is synthesized by the electronic device 510. In such implementations, the XR environment 522 is different from a physical environment in which the electronic device 510 is located. In some implementations, the XR environment 522 includes an augmented environment that is a modified version of a physical environment. For example, in some implementations, the electronic device 510 modifies (e.g., augments) the physical environment in which the electronic device 510 is located to generate the XR environment 522. In some implementations, the electronic device 510 generates the XR environment 522 by simulating a replica of the physical environment in which the electronic device 510 is located. In some implementations, the electronic device 510 generates the XR environment 522 by removing items from and/or adding items to the simulated replica of the physical environment in which the electronic device 510 is located.

In some implementations, the XR environment 522 includes various virtual objects such as an XR object 524 (“object 524”, hereinafter for the sake of brevity). In some implementations, the XR environment 522 includes multiple objects. In some implementations, the virtual objects are referred to as graphical objects or XR objects. In various implementations, the electronic device 510 obtains the objects from an object datastore (not shown). For example, in some implementations, the electronic device 510 retrieves the object 524 from the object datastore. In some implementations, the virtual objects represent physical articles. For example, in some implementations, the virtual objects represent equipment (e.g., machinery such as planes, tanks, robots, motorcycles, etc.). In some implementations, the virtual objects represent fictional elements (e.g., entities from fictional materials, for example, an action figure or a fictional equipment such as a flying motorcycle).

In some implementations, the virtual objects include a bounded region 526, such as a virtual workspace. The bounded region 526 may include a two-dimensional virtual surface 528a enclosed by a boundary and a two-dimensional virtual surface 528b that is substantially parallel to the two-dimensional virtual surface 528a. Objects 530a, 530b may be displayed on either of the two-dimensional virtual surfaces 528a, 528b. In some implementations, the objects 530a, 530b are displayed between the two-dimensional virtual surfaces 528a, 528b. In other implementations, bounded region 112 may be replaced by a single flat or curved two-dimensional virtual surface.

In some implementations, the electronic device 510 (e.g., the annotation engine 600) detects a gesture 532 directed to a graphical environment (e.g., the XR environment 522) that includes a first object and a second object, such as the object 530a and the object 530b. The user 520 may perform the gesture 532 using a user input entity 534, such as an extremity (e.g., a hand or a finger), a stylus or other input device, or a proxy for an extremity or an input device.

In some implementations, a distance d between a representation of the user input entity 534 and the first object (e.g., the object 530a) is greater than a threshold T. In some implementations, the representation 536 of the user input entity 534 is the user input entity 534 itself. For example, the electronic device 510 may be implemented as a head-mountable device (HMD) with a passthrough display. An image sensor and/or a depth sensor may be used to determine the distance between an extremity of the user 520 and the object to which the gesture 532 is directed. In this example, the XR environment 522 may include both physical objects (e.g., the user input entity 534) and virtual objects (e.g., object 530a, 530b) defined within a common coordinate system of the XR environment 522. Thus, while one object may exist in the physical world and the other may not, a distance or orientation difference may still be defined between the two. In some implementations, the representation 536 of the user input entity 534 is an image of the user input entity 534. For example, the electronic device 510 may incorporate a display that displays an image of an extremity of the user 520. The electronic device 510 may determine the distance d between the image of the extremity of the user 520 and the object to which the gesture 532 is directed.

In some implementations, the electronic device 510 (e.g., the annotation engine 600) determines a location to which the gesture 532 is directed. The electronic device 510 may select a markup mode based on the location to which the gesture 532 is directed.

In some implementations, as represented in FIG. 5A, if the gesture 532 is directed to a location corresponding to a first portion of the first object, the electronic device 510 (e.g., the annotation engine 600) generates an annotation 538 that is associated with the first object. In some implementations, the first portion of the first object comprises an interior portion of the first object, an exterior surface of the first object, or a location within a threshold distance of the first object. The annotation 538 may be displayed at a location that is determined based on the gesture and a gaze of the user or a projection of the user input entity on the object, as disclosed herein.

In some implementations, a markup mode may be selected from a plurality of candidate markup modes based on an object type of the first object. Certain types of objects may have default markup modes associated with them. For example, if an object is a bounded region, the default markup mode may be a mode in which annotations are associated with the graphical environment. Another example candidate markup mode that may be selected based on the object type may be a markup mode in which an annotation is generated and associated with the first object based on the gesture. Still another example candidate markup mode that may be selected based on the object type may be a markup mode in which a relationship is defined between the first object and a second object based on the gesture. In some implementations, selecting the markup mode includes disabling an invalid markup mode. Some object types may be incompatible with certain markup modes. For example, some object types may be ineligible for defining hierarchical relationships. For such object types, the electronic device 510 may not allow the markup mode to be selected in which relationships are defined between objects, even if the user performs a gesture that would otherwise result in the markup mode being selected.

In some implementations, as represented in FIG. 5B, if the gesture 532 starts at a location corresponding to a second portion (e.g., an edge region) of the first object and ends at a location corresponding to the second object (e.g., the object 530b), the electronic device 510 (e.g., the annotation engine 600) may define a relationship between the first object and the second object based on the gesture. For example, the electronic device 510 may define a hierarchical relationship between the first object and the second object and may optionally display a representation of the relationship (e.g., a line or curve connecting the two).

In some implementations, as represented in FIG. 5C, if the gesture 532 is directed to a location 540 that corresponds to neither the first object nor the second object, an annotation may be created. The annotation may be associated with the XR environment 522 rather than with a particular object (e.g., may be anchored to the bounded region 526, one of the two-dimensional virtual surfaces 528a, 528b, or other virtual surface).

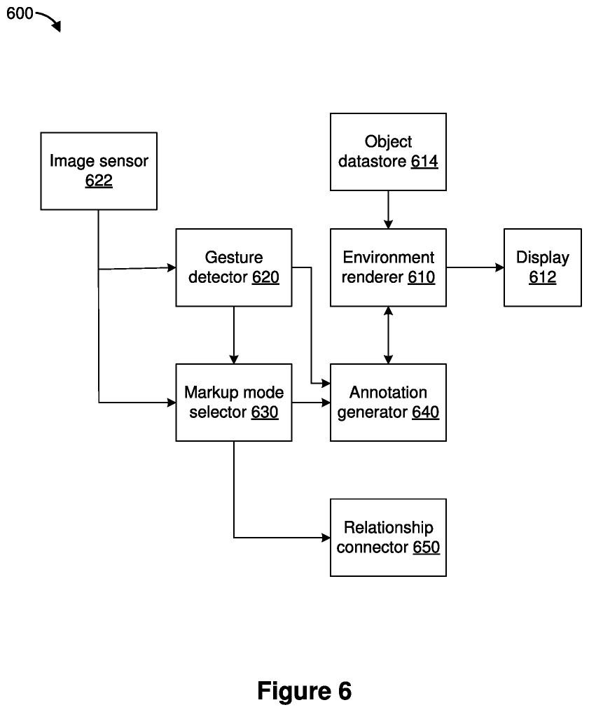

FIG. 6 illustrates a block diagram of the annotation engine 600 in accordance with some implementations. In some implementations, the annotation engine 600 includes an environment renderer 610, a gesture detector 620, a markup mode selector 630, an annotation generator 640, and a relationship connector 650. In various implementations, the environment renderer 610 causes a display 612 to present an extended reality (XR) environment that includes one or more virtual objects in a field of view. For example, with reference to FIGS. 5A, 5B, and 5C, the environment renderer 610 may cause the display 612 to present the XR environment 522. In various implementations, the environment renderer 610 obtains the virtual objects from an object datastore 614. The virtual objects may represent physical articles. For example, in some implementations, the virtual objects represent equipment (e.g., machinery such as planes, tanks, robots, motorcycles, etc.). In some implementations, the virtual objects represent fictional elements.

In some implementations, the gesture detector 620 detects a gesture that a user performs with a user input entity (e.g., an extremity or a stylus) in association with an object or location in the XR environment. For example, an image sensor 622 may capture an image, such as a still image or a video feed comprising a series of image frames. The image may include a set of pixels representing the user input entity. The gesture detector 620 may perform image analysis on the image to recognize the user input entity and detect the gesture (e.g., a pinching gesture, pointing gesture, holding a writing instrument gesture, or the like) performed by the user.

In some implementations, a distance between a representation of the user input entity and the first object is greater than a threshold. The representation of the user input entity may be the user input entity itself. For example, the user input entity may be viewed through a passthrough display. An image sensor and/or a depth sensor may be used to determine the distance between the user input entity and the first object. In some implementations, the representation of the user input entity is an image of the user input entity. For example, the electronic device may incorporate a display that displays an image of the user input entity.

In other implementations, other types of sensing modalities may be used. For example, a finger-wearable device, hand-wearable device, handheld device, or the like may have integrated sensors (e.g., accelerometers, gyroscopes, etc.) that can be used to sense its position or orientation and communicate (wired or wirelessly) the position or orientation information to electronic device 100. These devices may additionally or alternatively include sensor components that work in conjunction with sensor components in electronic device 100. The user input entity and electronic device 100 may implement magnetic tracking to sense a position and orientation of the user input entity in six degrees of freedom.

In some implementations, the markup mode selector 630 determines a location to which the gesture is directed. For example, the markup mode selector 630 may perform image analysis on the image captured by the image sensor 622 to determine a starting location and/or an ending location associated with the gesture. The markup mode selector 630 may select a markup mode based on the location to which the gesture is directed.

In some implementations, if the gesture is directed to a location corresponding to a first portion of the first object, the markup mode selector 630 selects an annotation mode. The annotation generator 640 generates an annotation that is associated with the first object. In some implementations, the first portion of the first object comprises an interior portion of the first object, an exterior surface of the first object, or a location within a threshold distance of the first object. The environment renderer 610 may display the annotation at a location that is determined based on the gesture and a gaze of the user or a projection of the user input entity on the object, as disclosed herein.

In some implementations, if the gesture starts at a location corresponding to a second portion (e.g., an edge region) of the first object and ends at a location corresponding to the second object, the markup mode selector 630 selects a connecting mode. The relationship connector 650 defines a relationship between the first object and the second object based on the gesture. For example, the relationship connector 650 may define a hierarchical relationship between the first object and the second object and may optionally display a representation of the relationship (e.g., a line or curve connecting the two).

In some implementations, if the gesture is directed to a location that corresponds to neither the first object nor the second object, the markup mode selector 630 selects a drawing mode. The annotation generator 640 generates an annotation that is associated with the XR environment rather than with a particular object (e.g., may be anchored to the bounded region 526, one of the two-dimensional virtual surfaces 528a, 528b, or other virtual surface). The environment renderer 610 may cause display 612 to present the annotation at a location that is determined based on the gesture and a gaze of the user or a projection of the user input entity on the object, as disclosed herein.

In some implementations, the markup mode selector 630 selects the markup mode from a plurality of candidate markup modes based on an object type of the first object. Certain types of objects may have default markup modes associated with them. For example, if an object is a bounded region, the default markup mode may be the drawing mode, in which annotations are associated with the graphical environment. Other example candidate markup modes that may be selected based on the object type may include the annotation mode and the connecting mode.

In some implementations, the markup mode selector 630 disables an invalid markup mode. Some object types may be incompatible with certain markup modes. For example, some object types may be ineligible for defining hierarchical relationships. For such object types, the markup mode selector 630 may not allow the markup mode to be selected in which relationships are defined between objects, even if the user performs a gesture that would otherwise result in the markup mode being selected. In such cases, the markup mode selector 630 may select a different markup mode instead and/or may cause a notification to be displayed.

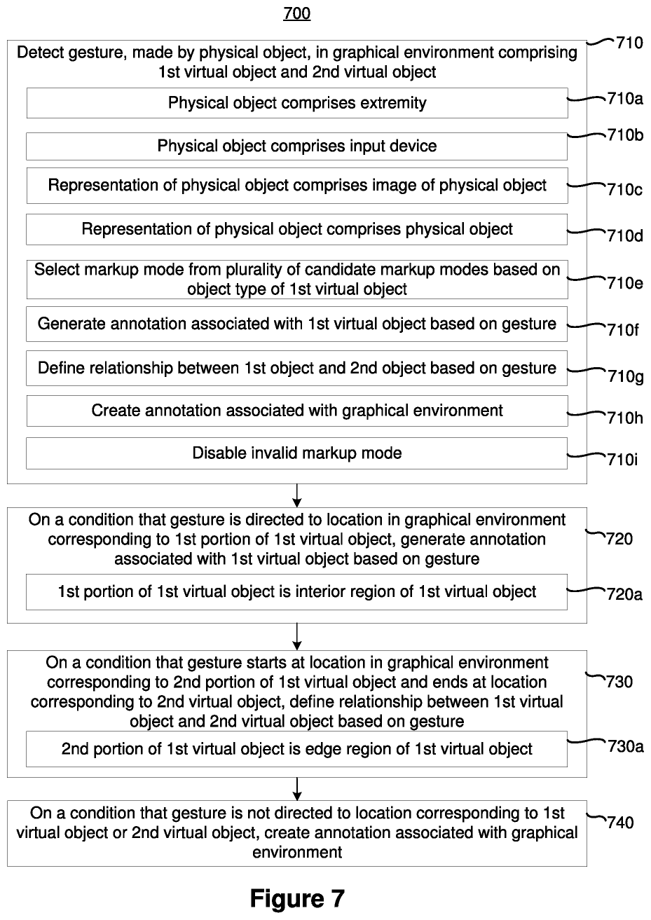

FIG. 7 is a flowchart representation of a method 700 for selecting a markup mode in accordance with various implementations. In various implementations, the method 700 is performed by a device (e.g., the electronic device 510 shown in FIGS. 5A-5C, or the annotation engine 600 shown in FIGS. 5A-5C and 6). In some implementations, the method 700 is performed by processing logic, including hardware, firmware, software, or a combination thereof. In some implementations, the method 700 is performed by a processor executing code stored in a non-transitory computer-readable medium (e.g., a memory).

In various implementations, an XR environment comprising a field of view is displayed. In some implementations, the XR environment is generated. In some implementations, the XR environment is received from another device that generated the XR environment.

The XR environment may include a virtual environment that is a simulated replacement of a physical environment. In some implementations, the XR environment is synthesized and is different from a physical environment in which the electronic device is located. In some implementations, the XR environment includes an augmented environment that is a modified version of a physical environment. For example, in some implementations, the electronic device modifies the physical environment in which the electronic device is located to generate the XR environment. In some implementations, the electronic device generates the XR environment by simulating a replica of the physical environment in which the electronic device is located. In some implementations, the electronic device removes and/or adds items from the simulated replica of the physical environment in which the electronic device is located to generate the XR environment.

In some implementations, the electronic device includes a head-mountable device (HMD). The HMD may include an integrated display (e.g., a built-in display) that displays the XR environment. In some implementations, the HMD includes a head-mountable enclosure. In various implementations, the head-mountable enclosure includes an attachment region to which another device with a display can be attached. In various implementations, the head-mountable enclosure is shaped to form a receptacle for receiving another device that includes a display. In some implementations, the display of the device attached to the head-mountable enclosure presents (e.g., displays) the XR environment. In various implementations, examples of the electronic device include smartphones, tablets, media players, laptops, etc.

Briefly, the method 700 includes detecting a gesture, made by a physical object, that is directed to a graphical environment that includes a first virtual object and a second virtual object. If the gesture is directed to a location in the graphical environment corresponding to a first portion of the first virtual object, an annotation is generated based on the gesture. The annotation is associated with the first virtual object. If the gesture starts at a location in the graphical environment corresponding to a second portion of the first virtual object and ends at a location in the graphical environment corresponding to the second virtual object, a relationship between the first virtual object and the second virtual object is defined based on the gesture. If the gesture is directed to a location in the graphical environment that corresponds to neither the first virtual object nor the second virtual object, an annotation associated with the graphical environment is generated.

In various implementations, as represented by block 710, the method 700 includes detecting a gesture directed to a graphical environment that includes a first virtual object and a second virtual object. In some implementations, a distance between a representation of a physical object and the first virtual object may be greater than a threshold. A user may perform the gesture using a physical object. In some implementations, as represented by block 710a, the physical object comprises an extremity of the user, such as a hand. As represented by block 710b, in some implementations, the physical object comprises an input device, such as a stylus.

An image sensor and/or a depth sensor may be used to determine the distance between the representation of the physical object and the first virtual object. In some implementations, as represented by block 710c, the representation of the physical object comprises an image of the physical object. For example, the electronic device may incorporate a display that displays an image of an extremity of the user. The electronic device may determine the distance between the image of the extremity of the user and the virtual object associated with the gesture. As represented by block 710d, in some implementations, the representation of the physical object comprises the physical object. For example, the electronic device may be implemented as a head-mountable device (HMD) with a passthrough display. An image sensor and/or a depth sensor may be used to determine the distance between an extremity of the user and the virtual object associated with the gesture.

In some implementations, as represented by block 710e, the method 700 includes selecting a markup mode from a plurality of markup modes based on an object type of the first virtual object. For example, certain types of objects may have default markup modes associated with them. In some implementations, as represented by block 710f, selecting the markup mode includes generating the annotation associated with the first virtual object based on the gesture. In some implementations, as represented by block 710g, selecting the markup mode includes defining the relationship between the first virtual object and the second virtual object based on the gesture. In some implementations, as represented by block 710h, selecting the markup mode includes creating an annotation that is associated with the graphical environment. For example, if the first virtual object is a bounded region (e.g., a workspace), this markup mode may be selected by default.

In some implementations, as represented by block 710i, selecting the markup mode includes disabling an invalid markup mode. Some object types may be incompatible with certain markup modes. For example, some object types may be ineligible for defining hierarchical relationships. For such object types, the electronic device may not allow the markup mode to be selected in which relationships are defined between objects, even if the user performs a gesture that would otherwise result in the markup mode being selected.

In various implementations, as represented by block 720, the method 700 includes generating an annotation associated with the first virtual object based on the gesture on a condition that the gesture is directed to a location in the graphical environment corresponding to a first portion of the first virtual object. An annotation that is associated with an object (e.g., the first virtual object) may be anchored to the object in the graphical environment. Accordingly, if a movement of the object is displayed in the graphical environment, a corresponding movement of the associated annotation may also be displayed in the graphical environment. In some implementations, as represented by block 720a, the first portion of the first virtual object comprises an interior portion of the first virtual object. The annotation may be displayed at a location that is determined based on the gesture and a gaze of the user or a projection of the physical object on the virtual object, as disclosed herein.

In various implementations, as represented by block 730, the method 700 includes defining a relationship between the first virtual object and the second virtual object based on the gesture on a condition that the gesture starts at a location in the graphical environment corresponding to a second portion of the first virtual object and ends at a location in the graphical environment corresponding to the second virtual object. For example, the electronic device 510 may define a hierarchical relationship between the first virtual object and the second virtual object. As represented by block 730a, the second portion of the first virtual object may be an edge region of the first virtual object. In some implementations, a visual representation of the relationship between the first virtual object and the second virtual object is displayed in the graphical environment. The visual representation may be anchored to the first virtual object and/or the second virtual object. Accordingly, if a movement of the first virtual object or the second virtual object is displayed in the graphical environment, a corresponding movement of the visual representation may also be displayed in the graphical environment.

In various implementations, as represented by block 740, the method 700 includes creating an annotation that is associated with the graphical environment on a condition that the gesture is directed to a location in the graphical environment corresponding to neither the first virtual object nor the second virtual object. The annotation may be associated with the graphical environment as a whole, e.g., rather than with a particular virtual object in the graphical environment. The annotation may be displayed at a location that is determined based on the gesture and a gaze of the user, as disclosed herein. In some implementations, an annotation that is associated with the graphical environment is not anchored to any objects in the graphical environment. Accordingly, displayed movements of objects in the graphical environment may not, per se, result in corresponding displayed movements of annotations that are associated with the graphical environment.

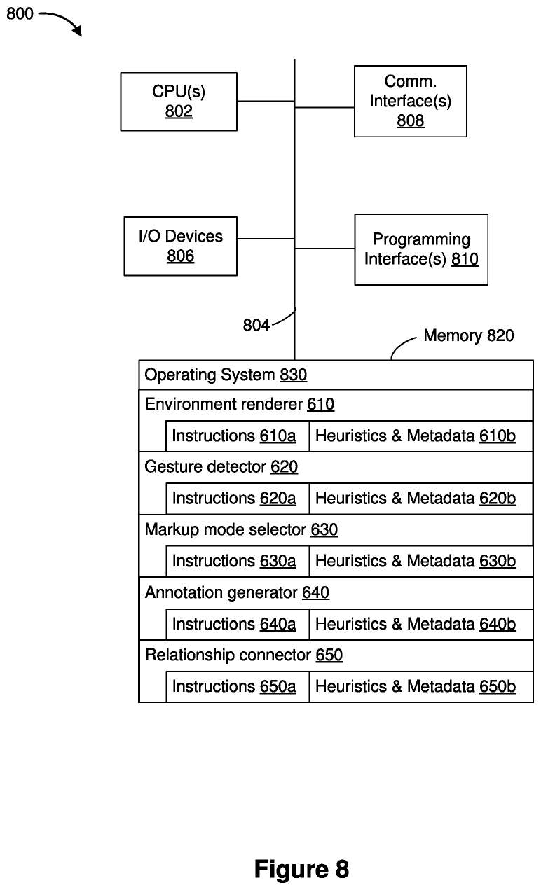

FIG. 8 is a block diagram of a device 800 in accordance with some implementations. In some implementations, the device 800 implements the electronic device 510 shown in FIGS. 5A-5C, and/or the annotation engine 600 shown in FIGS. 5A-5C and 6. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 800 includes one or more processing units (CPUs) 801, a network interface 802, a programming interface 803, a memory 804, one or more input/output (I/O) devices 810, and one or more communication buses 805 for interconnecting these and various other components.

In some implementations, the network interface 802 is provided to, among other uses, establish and/or maintain a metadata tunnel between a cloud hosted network management system and at least one private network including one or more compliant devices. In some implementations, the one or more communication buses 805 include circuitry that interconnects and/or controls communications between system components. In some implementations, the memory 804 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 804 may include one or more storage devices remotely located from the one or more CPUs 801. The memory 804 includes a non-transitory computer readable storage medium.

In some implementations, the memory 804 or the non-transitory computer readable storage medium of the memory 804 stores the following programs, modules and data structures, or a subset thereof including an optional operating system 806, the environment renderer 610, the gesture detector 620, the markup mode selector 630, the annotation generator 640, and the relationship connector 650. In various implementations, the device 800 performs the method 700 shown in FIG. 7.

In some implementations, the environment renderer 610 displays an extended reality (XR) environment that includes one or more virtual objects in a field of view. In some implementations, the environment renderer 610 performs some operation(s) represented by blocks 720 and 740 in FIG. 7. To that end, the environment renderer 610 includes instructions 610a and heuristics and metadata 610b.

In some implementations, the gesture detector 620 detects a gesture that a user performs with a user input entity (e.g., an extremity or a stylus) in association with an object in the XR environment. In some implementations, the gesture detector 620 performs the operation(s) represented by block 710 in FIG. 7. To that end, the gesture detector 620 includes instructions 620a and heuristics and metadata 620b.

In some implementations, the markup mode selector 630 determines a location to which the gesture is directed and selects an annotation mode. In some implementations, the markup mode selector 630 performs some of the operations represented by blocks 720, 730, and 740 in FIG. 7. To that end, the markup mode selector 630 includes instructions 630a and heuristics and metadata 630b.

In some implementations, the annotation generator 640 generates an annotation that is associated with the first object or with the XR environment. In some implementations, the annotation generator 640 performs some of the operations represented by blocks 720 and 740 in FIG. 7. To that end, the annotation generator 640 includes instructions 640a and heuristics and metadata 640b.

In some implementations, the relationship connector 650 defines a relationship between the first object and the second object based on the gesture. In some implementations, the relationship connector 650 performs some of the operations represented by block 730 in FIG. 7. To that end, the relationship connector 650 includes instructions 650a and heuristics and metadata 650b.

In some implementations, the one or more I/O devices 810 include a user-facing image sensor. In some implementations, the one or more I/O devices 810 include one or more head position sensors that sense the position and/or motion of the head of the user. In some implementations, the one or more I/O devices 810 include a display for displaying the graphical environment (e.g., for displaying the XR environment 522). In some implementations, the one or more I/O devices 810 include a speaker for outputting an audible signal.

In various implementations, the one or more I/O devices 810 include a video pass-through display which displays at least a portion of a physical environment surrounding the device 800 as an image captured by a scene camera. In various implementations, the one or more I/O devices 810 include an optical see-through display which is at least partially transparent and passes light emitted by or reflected off the physical environment.

FIG. 8 is intended as a functional description of various features which may be present in a particular implementation as opposed to a structural schematic of the implementations described herein. Items shown separately could be combined and some items could be separated. For example, some functional blocks shown separately in FIG. 8 could be implemented as a single block, and various functions of single functional blocks may be implemented by one or more functional blocks in various implementations. The actual number of blocks and the division of particular functions and how features are allocated among them can vary from one implementation to another and, in some implementations, may depend in part on the particular combination of hardware, software, and/or firmware chosen for a particular implementation.

Various aspects of implementations within the scope of the appended claims are described above. However, it should be apparent that the various features of implementations described above may be embodied in a wide variety of forms and that any specific structure and/or function described above is merely illustrative. Based on the present disclosure, one skilled in the art should appreciate that an aspect described herein may be implemented independently of other aspects and that two or more aspects described herein may be combined in various ways. For example, an apparatus may be implemented and/or a method may be practiced using a number of the aspects set forth herein. Additionally, such an apparatus may be implemented and/or such a method may be practiced using other structure and/or functionality in addition to or other than one or more of the aspects set forth herein.

1. A method comprising:
at a device comprising one or more processors, non-transitory memory, and one or more sensors:
detecting a gesture being performed via a first object in association with a second object in a graphical environment;
determining, via the one or more sensors, a distance between a representation of the first object and the second object;
on a condition that the distance is greater than a threshold, displaying a change in the graphical environment according to the gesture and a determined gaze; and
on a condition that the distance is not greater than the threshold, displaying the change in the graphical environment according to the gesture and a projection of the representation of the first object on the second object.

2. The method of claim 1, wherein the first object comprises an extremity.

3. The method of claim 1, wherein the first object comprises an input device.

4. The method of claim 1, wherein the representation of the first object comprises an image of the first object.

5. The method of claim 1, wherein the first object is a physical object and the second object is a virtual object.

6. The method of claim 1, further comprising, on a condition that the distance is not greater than the threshold, displaying a virtual writing instrument.

7. The method of claim 1, wherein the change in the graphical environment comprises a creation of an annotation associated with the second object.

8. The method of claim 1, wherein the change in the graphical environment comprises a modification of an annotation associated with the second object.

9. The method of claim 1, wherein the change in the graphical environment comprises a removal of an annotation associated with the second object.

10. The method of claim 1, wherein the change in the graphical environment comprises a manipulation of the second object.

11. The method of claim 1, further comprising applying a scale factor to the gesture.

12. The method of claim 11, further comprising selecting the scale factor based on the distance between the representation of the first object and the second object.

13. The method of claim 11, further comprising selecting the scale factor based on a size of the second object.

14. The method of claim 11, further comprising selecting the scale factor based on an input.

15. The method of claim 1, further comprising selecting a brush stroke type based on the distance between the representation of the first object and the second object.

16. The method of claim 1, further comprising, on a condition that the distance is greater than the threshold, displaying the change in the graphical environment according to a gaze vector based on a gaze and an offset determined based on a position of the first object.

17. The method of claim 16, further comprising displaying the change in the graphical environment at a location corresponding to an end portion of the first object.

18. The method of claim 1, wherein the device comprises a head-mountable device (HMD).

19. A device comprising:
one or more processors;
a non-transitory memory;
a display;
an audio sensor;
an input device; and
one or more programs stored in the non-transitory memory, which, when executed by the one or more processors, cause the device to;
detect a gesture being performed via a first object in association with a second object in a graphical environment;
determine, via the one or more sensors, a distance between a representation of the first object and the second object;
on a condition that the distance is greater than a threshold, display a change in the graphical environment according to the gesture and a determined gaze; and
on a condition that the distance is not greater than the threshold, display the change in the graphical environment according to the gesture and a projection of the representation of the first object on the second object.

20. A non-transitory memory storing one or more programs, which, when executed by one or more processors of a device, cause the device to:
detect a gesture being performed via a first object in association with a second object in a graphical environment;
determine, via the one or more sensors, a distance between a representation of the first object and the second object;
on a condition that the distance is greater than a threshold, display a change in the graphical environment according to the gesture and a determined gaze; and
on a condition that the distance is not greater than the threshold, display the chance in the graphical environment according to the gesture and a projection of the representation of the first object on the second object.

21-40. (canceled)
